(19) United States
(12) Patent Application Publication
(10) Pub. No.: US 2006/0227030 A1
(43) Pub. Date: Oct. 12, 2006

(54) Accelerometer based control system and method of controlling a device

(76) Inventors: Michelle A. Clifford, Chandler, AZ (US); John B. Young, Chandler, AZ (US)

Correspondence Address: INGRASSIA, FISHER & LORENZ, P.C., 7150 E. CAMELBACK ROAD, SUITE 325, SCOTTSDALE, AZ, 85251, US

(21) Appl. No.: 11/095,303

(22) Filed: Mar. 31, 2005

(51) Int. Cl. G08C 19/12

(52) U.S. Cl. 341/176

(57) ABSTRACT

A control system and method are provided for controlling a device. The control system includes a control mechanism (100, 200), including a plurality of accelerometers (102, 204) and a processor (104, 206) for generating at least one control signal. The plurality of accelerometers (102, 204) provide acceleration measurements to the processor (104, 206), the measurements describing the current acceleration of control mechanism (100, 200) in all directions. The processor (104, 206) receives the acceleration measurements and compares the acceleration measurements to a value range stored to determine if the movement of the control mechanism can be mapped to a pre-programmed motion stored during setup of the system, indicative of a control function. The processor (104, 206) generates at least one control signal in response to the detection of a pre-programmed motion. The control signal provides for control of a device (110, 202).

### FIELD OF THE INVENTION

This present invention generally relates to the field of control systems, and more particularly to an improved control system including a motion based user interface.

### BACKGROUND OF THE INVENTION

Many consumer devices provide for a user interface, including user identification, through levers, buttons, switches, buttons, joysticks, and other types of control mechanisms. Typically, these control mechanisms are rather large, cumbersome, and require user dexterity to operate. A mechanical forklift is one common example of a device using these types of controls for movement of the device. During operation, the individual controlling the forklift is required to move levers, push buttons, activate switches, or the like, to operate and control the lift. In most instances, positioning of the user within the forklift body is required to operate the control mechanisms.

Other consumer devices that provide user interface through levers, buttons, switches, or the like include medical devices, such as motorized wheelchairs and motorized beds. As an example, during operation of a motorized wheelchair, the user is required to move a joystick type lever in the direction of movement they want the wheelchair to move. Operation of the joystick can provide control of both the speed and direction of the wheelchair. Joystick operation requires the user or the operator to have both sufficient limb movement and limb strength. For those lacking sufficient limb strength and movement to operate a joystick, alternative user interfaces are known such as a chin-cup for chin operation and interface, a mouth pipe for sip and puff interface, and a modified headrest as a head control interface. Many times individuals may not have sufficient strength and movement to operate a joystick and prefer not to utilize these alternative user interfaces. In a few instances, there are ergonomically designed controllers or disability controllers that provide for a modified user interface. However, a design solution for each movement or control is necessary.

In addition, many consumer devices require the user to identify themselves to the device prior to use. One type of identification of a user currently found in consumer devices is biometric identification. Devices capable of biometric identification provide for the gathering and validating of biometric identifiers as a means of user interface. Biometric identification can include fingerprint recognition, voice print recognition, hand print recognition, or retinal scan identification. Today, biometric identification is being utilized in many consumer areas including computer networks, desktop PC's, workstations, cellular telephones, ATM machines, and the like. Human movement is considered a biometric character and would provide for an additional means for identification of a user of a consumer device.

An improved user interface is needed for identifying a user to a device and for operating and/or controlling a device. Accordingly, it is desirable to provide for a user interface that is capable of identifying to the device the identity of the user through simple user movement. In addition, it is desirable to provide for an improved user interface for controlling a device that provides for control of the device without operation of control knobs, levers, buttons, or the like. Other desirable features and characteristics of the present invention will become apparent from the subsequent detailed description of the invention and the appended claims, taken in conjunction with the accompanying drawings and this background of the invention.

### BRIEF DESCRIPTION OF DRAWINGS

The present invention will hereinafter be described in conjunction with the following drawing figures, wherein like numerals denote like elements, and

FIG. 1 is a block diagram of an accelerometer based mechanical control system in accordance with a first embodiment of the present invention;

FIG. 2 is a block diagram of an accelerometer based mechanical control system in accordance with a second embodiment of the present invention;

FIG. 3 is a flow diagram of a method of controlling a device using an accelerometer based mechanical control system according to the present invention; and

FIG. 4 is a flow diagram of the method of detecting movement in a control mechanism in accordance with an embodiment of the invention.

### DETAILED DESCRIPTION OF THE INVENTION

The present invention provides a system and method for controlling an electronic device by identifying a user to the device and operating the functions of the device using a control mechanism that incorporates accelerometers. The system operates by recognizing one or more movements, or series of movements, of the control mechanism and matching them to pre-programmed movements that represent control functions of the associated device. In one instance, the accelerometer-based system recognizes a movement, or a series of movements, of the control mechanism as a representation of the identification of the user. In another instance, the accelerometer-based system recognizes movements of the control mechanism to initiate mechanical control of a device. The control mechanism can be formed as a separate device or integrally formed in the device being controlled.

The control mechanism of the present invention can be programmed to recognize an unlimited number of user movements. The accelerometer-based control mechanism provides acceleration measurements to a processor in communication with the device being controlled. The processor determines if the acceleration measurements can be mapped or matched to pre-programmed movements of the control mechanism. If the movements are recognized, the processor generates a control sequence signal to initiate and complete an act that correlates to that movement. The same acts have typically been performed by activating a button, lever, switch, etc. Acts such as inputting identification information, turning, accelerating, lifting, or the like are easily performed by moving the accelerometer-based control mechanism. This type of user interface provides for a low cost solution by eliminating the need for expensive mechanical parts in the form of buttons, lever, switches, etc. As stated, the control system can also act as a biometric security system through recognition of a pre-programmed movement or series of pre-programmed movements, thereby presenting a lower cost solution than known biometric identification systems.

Turning now to the drawings, FIG. 1 illustrates in a schematic view an accelerometer based control system 100 for control of an electronic device 110. Control system 100, includes a control mechanism 105 for controlling an associated device 110 in response to user movement of control mechanism 105. In addition, control mechanism 105 provides biometric recognition of the user to device 110 through a series of recognized movements. Control mechanism 105 includes an accelerometer assembly for control of remotely located device 110. In this first embodiment control system 100, and more specifically control mechanism 105 comprises an accelerometer assembly 102, a processor 104 having inputs coupled to accelerometer assembly 102, and a means for transmitting at least one control signal to controlled device 110, such as a wireless transmitter 106 having inputs coupled to processor 104.

System 100 operates in dual modes: a SAVE mode and a USER mode. Typically system 100 is operated in a SAVE mode during initial setup of system 100. When operating in the SAVE mode, control mechanism 105 is moved in a series of movements that correspond to a control sequence the user wants to accomplish, whether initial identification of the operator to the device, or mechanical control of the device. Processor 104 downloads the acceleration measurement signals received from control mechanism 105, and more particularly accelerometer assembly 102, and saves them in memory (not shown) for subsequent mapping or matching of user movements during operation in USER mode. The memory could include, for example, internal memory of processor 104, or other suitable memory. When system 100 operates in the USER mode, processor 104 detects a movement, or sequence of movements, of control mechanism 105, represented by acceleration measurements that match or map to the programmed acceleration measurements stored in the memory of processor 104 that correlate to a specific device control function. Processor 104 will execute the respective command the acceleration measurements represent by generating an output control sequence signal when a match of the user's movements to the acceleration measurements stored in processor 104 is detected. The control signal is generated in response to the movements and transmitted to control device 110.

During USER mode, user interface and control of device 110 is accomplished by moving the control mechanism 105 in a pre-programmed manner. As an example, to accomplish user interface of a wheelchair, a disabled person holds a wireless control mechanism 105 in their hand. By tipping control mechanism 105 to the left, the plurality of accelerometers 102 provide acceleration measurements to processor 104, representative of the current acceleration in all directions of movement(s) by the user seeking to control the wheelchair. Processor 104 recognizes the movement of mechanism 100 to the left as matching a pre-programmed movement, and transmits a control signal to the wheelchair to turn left.

To detect a pre-programmed movement, processor 104 receives the acceleration measurements and compares the measurements to a series of pre-programmed measurements representing movements of control mechanism 105. In this first embodiment, when a pre-programmed movement is recognized, processor 104 generates an output signal of a control sequence, also referred to herein as a control signal, that is transmitted via transmitter 106 to a remote signal receiver 108. This submission of a control signal provides for control of remote device 110 or identification of the user to remote device 110. Receiver 108 receives a wirelessly transmitted output signal from control mechanism 105. Receiver 108 is designed to be housed within device 110.

As previously stated, control mechanism 105 can reliably detect movements of control mechanism 105 and match, or map, them to pre-programmed movements for controlling device 110. More specifically, during operation, processor 104 receives the acceleration measurements from accelerometer assembly 102 and compares the acceleration measurements to a value range to determine if the movement is a pre-programmed movement translating into a control sequence. Processor 104 provides an output signal of the control sequence to wireless transmitter 106 once a pre-programmed movement is detected. Wireless transmitter 106 transmits a signal directly to remote signal receiver 108 to control remote device 110.

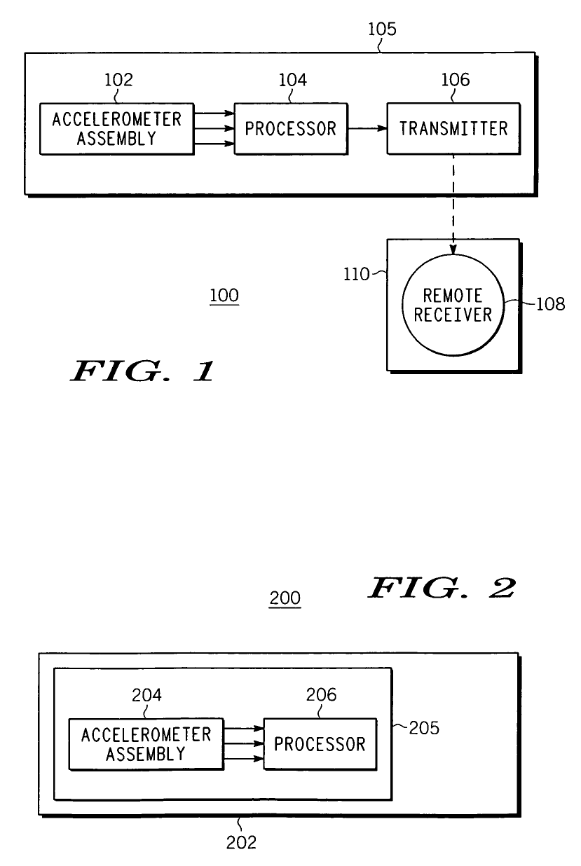

FIG. 2 illustrates in schematic view a control system 200, including an accelerometer based control mechanism 205 according to a second embodiment of the present invention. In contrast to the first embodiment, control mechanism 205 is housed within electronic device 202 and provides for operation of electronic device 202 and identification of the user to device 202 through biometric recognition. Accelerometer based control mechanism 205 comprises an accelerometer assembly 204 and a processor 206 having inputs coupled to accelerometer assembly 204. Microprocessor 206 is initially programmed using a SAVE mode with acceleration measurements of specific movements by the user of the device. The programming of the acceleration movements provides for biometric identification and control of device 202 when operating in USER mode. Microprocessor 206 is programmed to generate a control signal in response to a recognized pre-programmed movement. In the alternative, a separate microprocessor is included for control signal generation.

During operation, user interface and control of device 202 is accomplished by moving device 202, and more specifically control mechanism 205, in a manner that matches a pre-programmed movement. Processor 206 includes a series of pre-programmed movements that correlate to a specific control function. A control signal is generated in response to movements exerted upon control mechanism 205 when the movements are recognized as mapping to pre-programmed movements. As an example, to accomplish user interface of a cellular telephone, and in particular, identification of the user to the device and activation of address book function, a user holds a cellular phone 202 in their hand, having housed therein control mechanism 205. By repetitively tipping cellular phone 202 to the left, right, left, right the plurality of accelerometers 204 provide acceleration measurements to processor 206, representative of the current acceleration in all directions of movement(s) by the user seeking to control cellular phone 202. Processor 206 recognizes the movement of mechanism 200 as matching a pre-programmed movement indicating identification of the user. Processor 206 generates a control signal and in response the user is identified to cellular phone 202 and use of cellular phone 202 is enabled. Subsequent movement of phone 202 by tipping it twice to the left, provides for recognition of the movement of phone 200 as matching a pre-programmed movement and an address book function is activated.

To detect the pre-programmed movement, processor 206 receives the acceleration measurements and compares the measurements to a series of pre-programmed measurements representing movements of control mechanism 205. In this second embodiment, control mechanism 205 is designed to be housed within the cellular phone and is configured to recognize the movement of mechanism 205 and generate output signals for control of device 202.

A variety of different types of accelerometers can be used in the system and method. One specific type of accelerometer that can be used is a micromachined accelerometer. For example, micromachined accelerometers can be used to accurately measure acceleration using changes in capacitance. Capacitive micromachined accelerometers offer high sensitivity with low noise and low power consumption and thus are ideal for many applications. These accelerometers typically use surface micromachined capacitive sensing cells formed from semiconductor materials. Each cell includes two back-to-back capacitors with a center plate between the two outer plates. The center plate moves slightly in response to acceleration that is perpendicular to the plates. The movement of the center plate causes the distance between the plates to change. Because capacitance is proportional to the distance between plates, this change in distance between plates changes the capacitance of the two capacitors. This change in capacitance of the two capacitors is measured and used to determine the acceleration in the direction perpendicular to the plates, where the direction perpendicular to the plates is commonly referred to as the axis of the accelerometer.

Typically, micromachined accelerometers are packaged together with an application specific integrated circuit (ASIC) that measures the capacitance, extracts the acceleration data from the difference between the two capacitors in a cell, and provides a signal that is proportional to the acceleration. In some implementations, more than one accelerometer will be combined together in one package. For example, some implementations include three accelerometers, with each accelerometer configured to measure acceleration in a different orthogonal axis. The three accelerometers are designed or packaged together with the ASIC used to measure and provide the acceleration signals for all three directions. Other implementations are packaged with one accelerometer per device or two accelerometers per device. All of these implementations can be adapted for use in the system and method of the present invention.

One suitable accelerometer that can be adapted for use in the system and method is a triple-axis accelerometer MMA7260Q available from Freescale Semiconductor, Inc. This accelerometer provides the advantage of measuring acceleration in all three directions with a single package. Other suitable accelerometers include dual axis accelerometer MMA6260Q and single axis accelerometer MMA1260D. Other types of accelerometers that can be used include a combination of MMA6161Q, MMA6262Q, MMA6263Q, and MMA2260D with the MMA1260D or by mounting a device on its side to achieve 3-axis sensing. Of course, these are just some examples of the type of accelerometers that can be used in the system and method of the present invention.

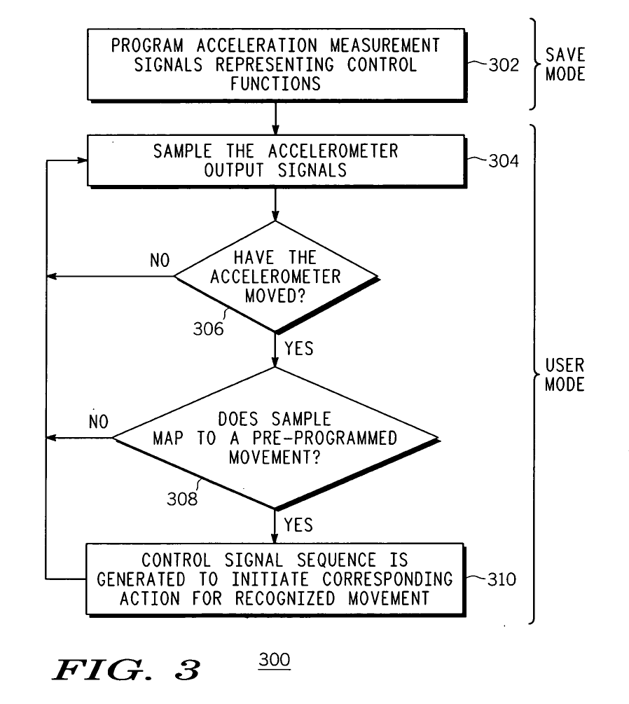

FIG. 3 illustrates a method 300 of controlling a device using an accelerometer based mechanical control system according to the present invention. Method 300 provides for the ability to control a device using a control system, such as that described in FIGS. 1 and 2. Method 300 provides for the saving of a movement or series of movements of a control mechanism to the processor and subsequent mapping of movements to pre-programmed movements of the control mechanism to control the device. First, accelerometer measurements signals are programmed using SAVE mode (302) into a processor associated with the device being controlled. The accelerometer measurement signals are received by the processor from an accelerometer based control mechanism such as described in FIGS. 1 and 2. Typically the accelerometer measurement signals are provided by at least three accelerometers, where the at least three accelerometers are configured to measure acceleration in three orthogonal directions. Thus, there is at least one accelerometer measuring acceleration in an X-axis, at least one accelerometer measuring acceleration in a Y-axis, and at least one accelerometer measuring acceleration in a Z-axis, where X, Y and Z are orthogonal axes. Of course, different arrangements of accelerometers could be used in some embodiments.

Subsequent to initial programming of the device, accelerometer measurement signals are received (304) from the control mechanism by operating the device in USER mode. With the accelerometer measurement signals received, the next step (306) is to determine if the accelerometers have moved, meaning has the user exerted a force upon the control mechanism as a means to initiate control of a device, through identification or mechanical control. If it is determined that the accelerometers have not moved in step 306, the method then returns to step 304 for the receipt of additional data. As will be described in detail below, one method of determining if movement of the control mechanism is occurring is to compare the measurement signals to a value range, where the value range represents a pre-programmed movement. If the measurement signals for each axis are each within a specified value range for a specified number of measurements, then movement of the control mechanism is recognized as matching a pre-programmed movement (308) and a control signal is generated (310) to initiate a corresponding action of a device. If it is determined that the measurement signals to do not map to a pre-programmed movement, the method then returns to step 304 for the receipt of additional data.

Once the control signal is generated in step 310, the method returns to step 304 where data is continuously received and evaluated to determine if a movement is exerted upon the mechanism for controlling a device. It should be noted that the steps in method 300 are merely exemplary, and that other combinations of steps or orders of steps can be used to provide for control of the device using the control mechanism of the present invention.

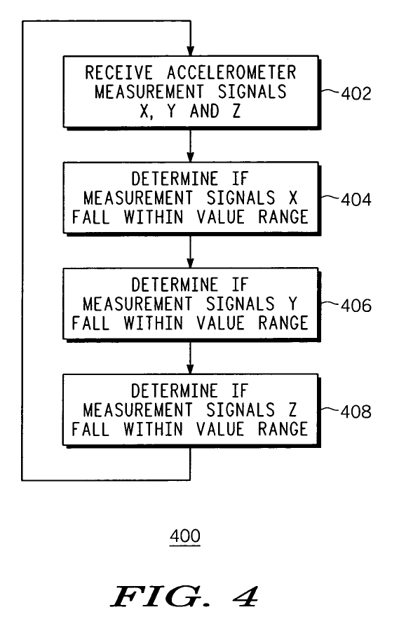

FIG. 4 illustrates a method 400 for detecting a movement of a control mechanism. The method 400 is used to implement step 306 in method 300 (FIG. 3). The method 400 is based on the observation that movement of a control mechanism as a means of user interface with a device will have acceleration measurements in all directions go toward a specific value that corresponds to a specific pre-programmed movement when the control mechanism is being moved in a manner consistent with the desire to control a device. Thus, the method 400 compares measurements from each accelerometer to a selected value range, with the value range defining a set of acceleration values. The value range used would depend on a variety of factors. Typically, the larger the value range, the more likely a movement will be detected when it occurs. However, a larger value range will also increase the likelihood that unintentional movements of the control mechanism are erroneously determined to be intentional movements.

In the first step (402) accelerometer measurement signals x, y and z are received, with the signals corresponding to measurements in X, Y and Z orthogonal directions. The format of the measurement signals would typically depend on the accelerometers used and how the output of the accelerometers is processed. Typical accelerometers provide a voltage that is proportional to the acceleration as an output. This output voltage can then be converted to a digital representation using an appropriate analog-to-digital converter. The conversion can be done by the processor, by the ASIC associated with accelerometers, or with separate converters. The number of bits used to represent the output would typically depend on a variety of factors, such as the desired resolution and the cost of components. As one example, an eight-bit solution can be used that would provide a range of two hundred and fifty-six possible acceleration values. Additionally, the rate at which the analog-to-digital conversion is performed would depend upon the speed of the various components. For example, a typical suitable converter would provide digital values from the analog signals at a rate of 200 Hz.

In the next step (404) it is determined if measurement signals x fall within a value range and can be mapped to a pre-programmed movement representing a control function. As stated above, the value range defines a margin of acceleration values. One exemplary value range covers a specific g measurement (i.e. gravity) within minimal plus/minus percentage. Likewise, it is next determined if measurement signals y fall within the value range (step 406), and next it is determined if the measurements signals z fall within the value range (step 408).

Typically, steps 404, 406 and 408 would be implemented such that specific movement of control mechanism is detected only when measurement signals x, y, and z are determined to be within the value range for a selected period of time. Requiring that each signal x, y, and z be in the value range for a predetermined time period reduces the probability that random movements that result in measurement signals will be misinterpreted as indicative of intentional movement of the control mechanism. As one example, steps 404, 406 and 408 can be implemented such that the signals are determined to fall within the value range when the signals are within the value range for at least 1/20 of a second. In a system where digital measurement signals are provided at 200 Hz, an intentional movement of the control mechanism would thus be determined when ten consecutive measurements are within the value range for each axis simultaneously. Such an implementation facilitates detection of relatively fast movements of control mechanism while reducing the likelihood of erroneous detections.

Steps 402-408 of method 400 would be performed in real time, with the processor continually receiving measurement signals and determining if the past sets of measurement signals have been within the value range for a predetermined time period and match a pre-programmed movement. This can be accomplished by continually loading the measurements into an appropriate FIFO buffer and evaluating the contents of the buffer to determine if the criteria are met for each set of measurement signals, then loading the next set of measurements, and removing the oldest set of measurements.

The accelerometer based control mechanism can be implemented with a variety of different types and configurations of devices. As discussed above, the method includes a processor that performs the computation and generates a control sequence output signal. The processor may comprise any suitable type of processing device, including single integrated circuits such as a microprocessor, or combinations of devices working in cooperation to accomplish the functions of a processing unit. In addition, the processor may part of the electronic device's core system or a device separate to the core system. Furthermore, it should be noted that in some cases it will be desirable to integrate the processor functions with the accelerometers. For example, a suitable state machine or other control circuitry integrated with the accelerometers can implement the plurality of accelerometers and the processor in a single device solution. In such a system circuitry can be used to directly determine if the accelerometer plates are close to a zero position, and provide the warning to the device.

The processor can comprise special purpose hardware configured for fault detection. Alternatively, the processor can comprise a programmable processor that executes programs stored in a suitable memory, with the programs configured to provide fault detection. Thus, those skilled in the art will recognize that the mechanisms of the present invention are capable of being distributed as a program product in a variety of forms, and that the present invention applies equally regardless of the particular type of signal bearing media used to carry out the distribution. Examples of signal bearing media include: recordable media such as floppy disks, hard drives, memory cards and optical disks, and transmission media such as digital and analog communication links, including wireless communication links.

The present invention thus provides a system for controlling a device. The system comprising: an accelerometer assembly for measuring acceleration of a control mechanism in at least one direction and generating signals representative of the control mechanism's acceleration; and a processor having inputs coupled to the accelerometer assembly for receiving the signals representative of the control mechanism's acceleration. The processor further storing said signals as an acceleration pattern of at least one pre-programmed control mechanism movement and determining if said signals match the acceleration pattern of the pre-programmed control mechanism movement. The processor generates at least one control signal in response to the matching of the acceleration pattern to initiate a device control function.

The device control function corresponds to a biometric identification or mechanical control of a device. The system further comprises a receiver configured to receive the at least one control signal for controlling the device. The control mechanism further comprises a wireless transmitter for transmitting the at least one control signal to the receiver of the device. The control mechanism can be formed integral the device being controlled. The control mechanism provides for control of a remote device. The accelerometer assembly includes one accelerometer measuring acceleration of the control mechanism in one direction and producing one acceleration measurement or a plurality of accelerometers, where the plurality of accelerometers measure acceleration of the control mechanism in a plurality of directions and produce a plurality of acceleration measurements. The plurality of accelerometers comprise a first accelerometer providing a first acceleration measurement x, a second accelerometer providing a second acceleration measurement y, and a third accelerometer providing a third acceleration measurement z, and wherein the processor determines if the plurality of acceleration measurements match a pre-programmed movement. The plurality of accelerometers comprise a first accelerometer measuring acceleration in a X direction, a second accelerometer measuring acceleration in a Y direction, and a third accelerometer measuring acceleration in a Z direction, where X, Y and Z are perpendicular to each other.

A system for controlling a device, the system comprising a control mechanism, wherein the control mechanism includes at least one accelerometer for measuring acceleration of the control mechanism in at least one direction and generating signals representative of the control mechanism's acceleration. The system further includes a processor having inputs coupled to the at least one accelerometer for receiving the signals representative of the control mechanism's acceleration. The processor stores said signals as an acceleration pattern of at least one pre-programmed movement and determines if said signals match the acceleration pattern of the pre-programmed movement. The processor generates at least one control signal in response to the matching of the acceleration pattern of the pre-programmed movement. The system further includes a transmitter having inputs coupled to the processor for transmitting the at least one control signal and a receiver for receiving the at least one control signal generated by the processor.

The control mechanism includes a first accelerometer providing a first acceleration measurements x, a second accelerometer providing a second acceleration measurements y, and a third accelerometer providing a third acceleration measurements z. The processor compares the first acceleration measurements x, the second acceleration measurements y, and the third acceleration measurements z to a value range, and determines if a pre-programmned movement is occurring if the first acceleration measurements x, the second acceleration measurements y, and the third acceleration measurements z are each within the value range for a first selected number of measurement samples. The processor then generates a control signal in response to the detected movement.

The present invention additionally provides for a method for controlling a device comprising the steps of: programming at least one acceleration measurement in a device as a programmed movement of a control mechanism by measuring acceleration of the control mechanism in at least one direction and producing at least one acceleration measurement, wherein the programmed movement represents a control function; measuring acceleration of a control mechanism in a plurality of directions and producing a plurality of acceleration measurements and mapping the at least one acceleration measurement to a value range to determine if the at least one acceleration measurement is within the value range indicating the programmed movement of the control mechanism has occurred. The method further includes the steps transmitting the at least one control signal to a signal receiver to control a device. The control mechanism can be formed integral a device being controlled.

The step of measuring acceleration of a control mechanism in at least one direction and producing at least one acceleration measurement includes measuring acceleration of a control mechanism in a plurality of directions and producing a plurality of acceleration measurements. The plurality of acceleration measurements are received from the plurality of accelerometers that comprise a first accelerometer measuring acceleration in a X direction, a second accelerometer measuring acceleration in a Y direction, and a third accelerometer measuring acceleration in a Z direction, where X, Y and Z are perpendicular to each other. The method further including the step of comparing a first acceleration measurement x, a second acceleration measurement y, and a third acceleration measurements z to a value range, wherein a pre-programmed movement of the control mechanism indicative of a control function is determined to be occurring if the first acceleration measurement x, the second acceleration measurement y, and the third acceleration measurement z are each within the value range for a first selected number of measurements.

While a plurality of exemplary embodiments have been presented in the foregoing detailed description, it should be appreciated that additional variations exist. It should also be appreciated that the exemplary embodiments are only examples, and are not intended to limit the scope, applicability, or configuration of the invention in any way. Rather, the foregoing detailed description will provide those skilled in the art with a convenient road map for implementing the exemplary embodiments. It should be understood that various changes can be made in the function and arrangement of elements without departing from the scope of the invention as set forth in the appended claims and the legal equivalents thereof.

1. A control system comprising:
an accelerometer assembly for measuring acceleration of a control mechanism in at least one direction and generating signals representative of the control mechanism's acceleration; and
a processor having inputs coupled to the accelerometer assembly for receiving the signals representative of the control mechanism's acceleration, storing said signals as an acceleration pattern of at least one pre-programmed control mechanism movement, determining if said signals match the acceleration pattern of the pre-programmed control mechanism movement, and generating at least one control signal in response to the matching of the acceleration pattern to initiate a device control function.

2. A control system as claimed in claim 1, wherein the device control function corresponds to a biometric identification.

3. A control system as claimed in claim 1, wherein the device control function corresponds to mechanical control of a device.

4. A control system as claimed in claim 1, wherein the system further comprises a receiver configured to receive said at least one control signal for controlling the device.

5. A control system as claimed in claim 4, wherein the control mechanism further comprises a wireless transmitter for transmitting the at least one control signal to the receiver of the device.

6. A control system as claimed in claim 1, wherein the control mechanism is integral the device being controlled.

7. A control system as claimed in claim 1, wherein the control mechanism provides for control of a remote device.

8. A control system as claimed in claim 1, wherein the accelerometer assembly includes one accelerometer measuring acceleration of the control mechanism in one direction and producing one acceleration measurement.

9. A control system as claimed in claim 1, wherein the accelerometer assembly includes a plurality of accelerometers, the plurality of accelerometers measuring acceleration of the control mechanism in a plurality of directions and producing a plurality of acceleration measurements.

10. A control system as claimed in claim 9, wherein the plurality of accelerometers comprise a first accelerometer providing a first acceleration measurement x, a second accelerometer providing a second acceleration measurement y, and a third accelerometer providing a third acceleration measurement z, and wherein the processor determines if the plurality of acceleration measurements match a pre-programmed movement.

11. A control system as claimed in claim 9, wherein the plurality of accelerometers comprise a first accelerometer measuring acceleration in a X direction, a second accelerometer measuring acceleration in a Y direction, and a third accelerometer measuring acceleration in a Z direction, where X, Y and Z are perpendicular to each other.

12. A control system, the system comprising:
a control mechanism, the control mechanism comprising:
at least one accelerometer for measuring acceleration of the control mechanism in at least one direction and generating signals representative of the control mechanism's acceleration;
a processor having inputs coupled to the at least one accelerometer for receiving the signals representative of the control mechanism's acceleration, storing said signals as an acceleration pattern of at least one pre-programmed movement, determining if said signals match the acceleration pattern of the pre-programmed movement, and generating at least one control signal in response to the matching of the acceleration pattern of the pre-programmed movement;
a transmitter having inputs coupled to the processor for transmitting the at least one control signal; and
a receiver for receiving the at least one control signal generated by the processor.

13. A control system as claimed in claim 12, wherein the control mechanism includes a first accelerometer providing a first acceleration measurement x, a second accelerometer providing a second acceleration measurement y, and a third accelerometer providing a third acceleration measurement z.

14. A control system as claimed in claim 13, wherein the processor compares the first acceleration measurement x, the second acceleration measurement y, and the third acceleration measurement z to a value range, and determines if a pre-programmed movement is matched if the first acceleration measurement x, the second acceleration measurement y, and the third acceleration measurement z are each within the value range for a first selected number of measurement samples.

15. A method for controlling a device, the method comprising the steps of:
programming at least one acceleration measurement in a device as a programmed movement of a control mechanism by measuring acceleration of the control mechanism in at least one direction and producing at least one acceleration measurement, wherein the programmed movement represents a control function;
measuring acceleration of the control mechanism in at least one direction and producing at least one acceleration measurement and mapping the at least one acceleration measurement to a value range to determine if the at least one acceleration measurement is within the value range indicating the programmed movement of the control mechanism has occurred; and
generating at least one control signal in response to the mapping of the programmed movement.

16. A method for controlling a device as claimed in claim 15, further including the step of transmitting the at least one control signal to a signal receiver to control a device.

17. A method for controlling a device as claimed in claim 15, wherein the control mechanism is formed integral a device being controlled.

18. A method for controlling a device as claimed in claim 15, wherein the step of measuring acceleration of a control mechanism in at least one direction and producing at least one acceleration measurements includes measuring acceleration of a control mechanism in a plurality of directions and producing a plurality of acceleration measurements.

19. A method for controlling a device as claimed in claim 18, wherein the plurality acceleration measurements are received from the plurality of accelerometers that comprise a first accelerometer measuring acceleration in a X direction, a second accelerometer measuring acceleration in a Y direction, and a third accelerometer measuring acceleration in a Z direction, where X, Y and Z are perpendicular to each other.

20. A method for controlling a device as claimed in claim 19, further including the step of comparing a first acceleration measurement x, a second acceleration measurement y, and a third acceleration measurements z to a value range, wherein a pre-programmed movement of the control mechanism indicative of a control function is determined to be occurring if the first acceleration measurement x, the second acceleration measurement y, and the third acceleration measurement z are each within the value range for a first selected number of measurements.
